(19) United States
(12) Patent Application Publication
(10) Pub. No.: US 2022/0172745 A1
(43) Pub. Date: Jun. 2, 2022

(54) Acoustic Parameter Editing Method, Acoustic Parameter Editing System, Management Apparatus, and Terminal

(71) Applicant: Yamaha Corporation, Hamamatsu-shi (JP)

(72) Inventor: Akihiro MIWA, Kosai-shi (JP)

(21) Appl. No.: 17/455,731

(22) Filed: Nov. 19, 2021

(30) Foreign Application Priority Data
Nov. 27, 2020 (JP) 2020-196523

(51) Int. Cl. G11B 27/031

(52) U.S. Cl. CPC G11B 27/031

(57) ABSTRACT

An acoustic parameter editing method is used in a management apparatus and a terminal. The management apparatus includes a first parameter memory configured to indicate an acoustic parameter and is connected to a sound signal processing engine configured to perform a sound signal processing by reflecting the acoustic parameter. The terminal includes a second parameter memory having the same memory structure as that of the first parameter memory in at least apart thereof. The management apparatus receives the acoustic parameter to update the first parameter memory. The terminal receives the acoustic parameter to update the second parameter memory when not connected to the management apparatus, and to update the first parameter memory when connected to the management apparatus. When the first parameter memory is updated, the terminal updates the second parameter memory in synchronization with the updated first parameter memory.

### CROSS-REFERENCE TO RELATED APPLICATIONS

This application is based on and claims priority under 35 USC 119 from Japanese Patent Application No. 2020-196523 filed on Nov. 27, 2020, the contents of which are incorporated herein by reference.

### TECHNICAL FIELD

An embodiment of the present invention relates to an acoustic parameter editing method, an acoustic parameter editing system, a management apparatus, and a terminal.

### BACKGROUND ART

A mixer can store currently set acoustic parameters in a scene memory as scene data. A user can reproduce acoustic parameters set in the past in the mixer by recalling the scene data. Accordingly, for example, the user can immediately call an optimum value for each scene set during a rehearsal of a concert. Such a reproduction operation is referred to as “scene recall”.

Patent Literature 1 discloses an acoustic system that can synchronize a scene memory by a plurality of mixers.

### CITATION LIST

### Patent Literature

Patent Literature 1: JP-2010-226322-A

### SUMMARY OF INVENTION

The user may want to edit acoustic parameters by using an information processing terminal used by the user himself/herself even in a place other than a venue where an acoustic device such as a mixer is installed.

Therefore, an object of an embodiment of the present invention is to provide an acoustic parameter editing method, an acoustic parameter editing system, a management apparatus, and a terminal that can edit acoustic parameters even in a place other than a venue where an acoustic device is installed.

In an embodiment of the present invention, an acoustic parameter editing method is used in a management apparatus and a terminal. The management apparatus includes a first parameter memory configured to indicate an acoustic parameter, and is connected to a sound signal processing engine configured to perform a sound signal processing by reflecting the acoustic parameter. The terminal includes a second parameter memory that has the same memory structure as that of the first parameter memory in at least a part thereof. The acoustic parameter editing method includes updating, by the management apparatus, the first parameter memory of the management apparatus after receiving the acoustic parameter; updating, by the terminal, the second parameter memory of the terminal after receiving the acoustic parameter when the terminal is not connected to the management apparatus; updating, by the terminal, the first parameter memory of the management apparatus after receiving the acoustic parameter when the terminal is connected to the management apparatus; and updating, by the terminal, the second parameter memory in synchronization with the updated first parameter memory when the first parameter memory is updated.

According to an embodiment of the present invention, acoustic parameters can be edited even in a place other than a venue where an acoustic device is installed.

### BRIEF DESCRIPTION OF DRAWINGS

FIG. 1 is a block diagram showing a configuration of an acoustic parameter editing system 1.

FIG. 2 is a block diagram showing a configuration of a mixer 11.

FIG. 3 is a functional block diagram of a signal processing implemented by a digital signal processor 204 and a CPU 206.

FIG. 4 is a block diagram showing a configuration of a management apparatus 12.

FIG. 5 is a block diagram showing a configuration of an information processing terminal 16.

FIG. 6 is a flowchart showing an operation of the information processing terminal 16 in a state of being connected to the management apparatus 12.

FIG. 7 is a flowchart showing an operation of the information processing terminal 16 in a disconnected state with the management apparatus 12.

### DESCRIPTION OF EMBODIMENTS

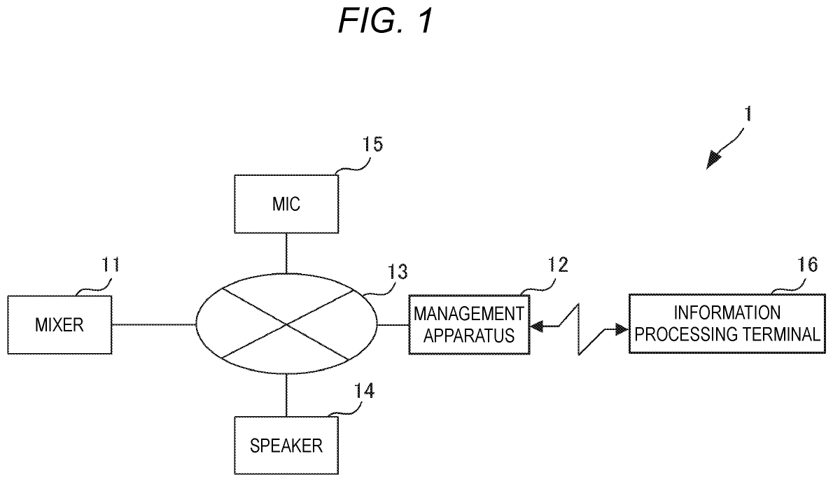

FIG. 1 is a block diagram showing a configuration of an acoustic parameter editing system 1. The acoustic parameter editing system 1 includes a mixer 11, a management apparatus 12, a network 13, a speaker 14, a microphone 15, and an information processing terminal 16.

The mixer 11, the speaker 14, the microphone 15, and the management apparatus 12 are connected via a network cable. The management apparatus 12 is connected to the information processing terminal 16 via wireless communication.

However, in the present invention, connection among the devices is not limited to this example. For example, the mixer 11, the speaker 14, and the microphone 15 may be connected by an audio cable. Further, the management apparatus 12 and the information processing terminals 16 may be connected via wired communication, or may be connected by a communication line such as a USB cable.

The mixer 11 receives a sound signal from the microphone 15. Further, the mixer 1011 outputs the sound signal to the speaker 14. In the present embodiment, the speaker 14 and the microphone 15 are shown as examples of an acoustic device connected to the mixer 11, but in practice, a large number of acoustic devices are connected to the mixer 11. The mixer 11 receives sound signals from a plurality of acoustic devices such as the microphone 15, performs a signal processing such as mixing, and outputs the sound signals to the plurality of acoustic devices such as the speaker 14.

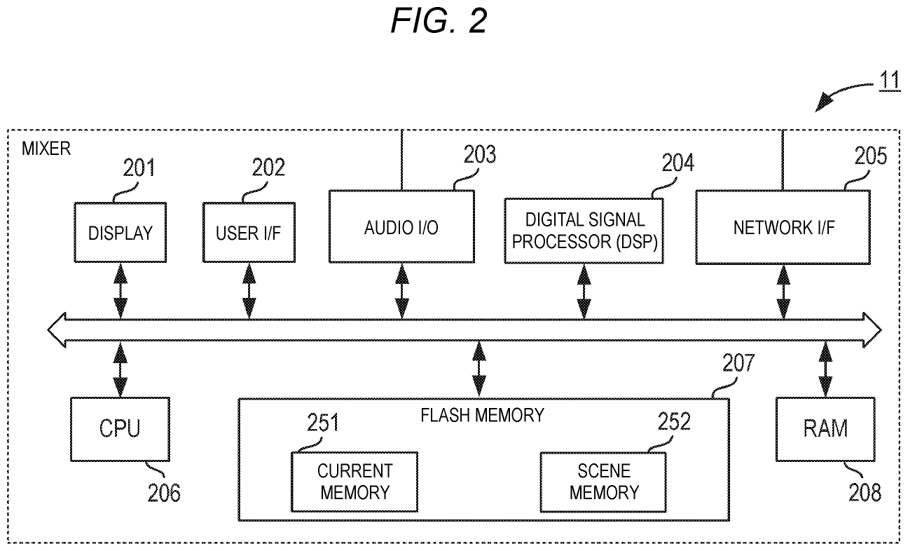

FIG. 2 is a block diagram showing a configuration of the mixer 11. The mixer 11 includes a display 201, a user I/F 202, an audio input/output (I/O)203, a digital signal processor (DSP) 204, a network I/F 205, a CPU 206, a flash memory 207, and a RAM 208.

The CPU 206 is a control unit that controls an operation of the mixer 11. The CPU 206 performs various operations by reading a predetermined program stored in the flash memory 207, which is a storage medium, into the RAM 208 and executing the program.

The program read by the CPU 206 does not need to be stored in the flash memory 207 in the own apparatus. For example, the program may be stored in a storage medium of an external apparatus such as a server. In this case, the CPU 206 may read the program from the server into the RAM 208 and execute the program each time.

The digital signal processor 204 is configured with the DSP for performing signal processing. The digital signal processor 204 performs a signal processing such as a mixing processing and a filter processing on a sound signal input from an acoustic device such as the microphone 15 via the audio I/O 203 or the network I/F 205. The digital signal processor 204 outputs an audio signal after the signal processing to an acoustic device such as the speaker 14 via the audio I/O 203 or the network I/F 205.

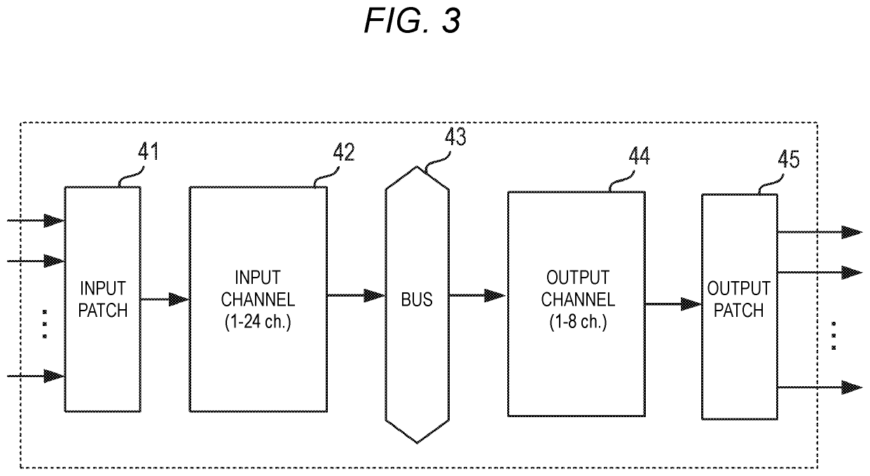

FIG. 3 is a functional block diagram of a signal processing implemented by the digital signal processor 204 and the CPU 206. As shown in FIG. 3, the signal processing is functionally performed by an input patch 41, an input channel 42, a bus 43, an output channel 44, and an output patch 45.

The input channel 42 has a signal processing function of a plurality of channels (for example, 24 channels). The input patch 41 assigns an acoustic device on an input side to any one of the channels of the input channel 42.

A sound signal is supplied from the input patch 41 to each channel of the input channel 42. Each channel of the input channel 42 performs signal processing on the input sound signal. Further, each channel of the input channel 42 sends the sound signal after the signal processing to the bus 43 in a subsequent stage.

The bus 43 mixes the input sound signals and outputs the mixed sound signals. The bus 43 includes a plurality of buses such as STL (stereo L) buses, STR (stereo R) buses, AUX buses, CUE buses for a monitor, or MIX buses.

The output channel 44 performs a signal processing on sound signals output from the plurality of buses. The output patch 45 assigns channels of the output channel 44 to an acoustic device on an output side. The output patch 45 outputs a sound signal via the audio I/O 203 or the network I/F 205.

A user sets the input patch 41, the input channel 42, the bus 43, the output channel 44, and the output patch 45 via the user I/F 202. The user sets, for example, a destination and a feed amount of a sound signal of each channel of the input channel 42. Acoustic parameters indicating settings of the input patch 41, the input channel 42, the bus 43, the output channel 44, and the output patch 45 are stored in a current memory 251. The digital signal processor 204 and the CPU 206 cause the input patch 41, the input channel 42, the bus 43, the output channel 44, and the output patch 45 to operate based on contents of the current memory 251. In this way, the mixer 11 functions as an example of a signal processing engine that performs a signal processing by reflecting the acoustic parameters of the current memory 251.

When the user operates the user I/F 202 to instruct to store a scene, the CPU 206 stores the contents of the current memory 251 in a scene memory 252 as one piece of scene data. The number of scene data stored in the scene memory 252 is not limited to one. The scene memory 252 may store a plurality of pieces of scene data. The user can call (recall) setting values of various acoustic parameters by calling optional scene data from the plurality of pieces of scene data.

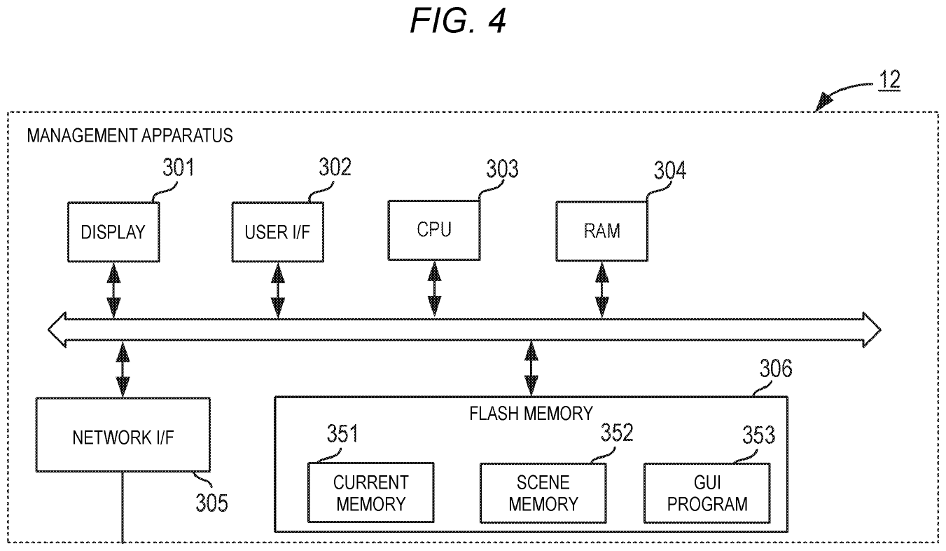

Next, FIG. 4 is a block diagram showing a configuration of the management apparatus 12. The management apparatus 12 is, for example, an information processing apparatus such as a personal computer or a dedicated embedded system.

The management apparatus 12 includes a display 301, a user I/F 302, a CPU 303, a RAM 304, a network I/F 305, and a flash memory 306.

The CPU 303 reads a program stored in the flash memory 306, which is a storage medium, into the RAM 304 to implement a predetermined function. The program read by the CPU 303 also does not need to be stored in the flash memory 306 in the own apparatus. For example, the program may be stored in a storage medium of an external apparatus such as a server. In this case, the CPU 303 may read the program from the server into the RAM 304 and execute the program each time.

The flash memory 306 includes a current memory 351, a scene memory 352, and a GUI program 353. The current memory 351 and the scene memory 352 correspond to a first parameter memory of the present invention. The GUI program 353 corresponds to a first program code for providing a GUI. The management apparatus 12 provides the user with the GUI by a first system including the current memory 351, the scene memory 352, and the GUI program 353.

The GUI program 353 may be a native application program that operates on an operating system of the management apparatus 12, but may be, for example, a web application program. When the GUI program 353 is the web application program, the user receives a GUI from the GUI program 353 via an application program of a web browser. Accordingly, the user can edit the current memory 351 and the scene memory 352 via the GUI program 353.

The current memory 351 and the scene memory 352 are synchronized with the current memory 251 and the scene memory 252 of the mixer 11. For example, when the user operates the user I/F 202 of the mixer 11 to change the acoustic parameters, the mixer 11 updates the contents of the current memory 251, and transmits the updated contents of the current memory 251 to the management apparatus 12. The CPU 303 receives the updated contents of the current memory 251 via the network I/F 305, and synchronizes contents of the current memory 351 with the updated contents of the current memory 251. Further, when the user operates the user I/F 202 to register new scene data, edit contents of the scene data, or delete the scene data, the mixer 11 updates contents of the scene memory 252. The mixer 11 transmits the updated contents of the scene memory 252 to the management apparatus 12. The CPU 303 receives the updated contents of the scene memory 252 via the network I/F 305, and synchronizes contents of the scene memory 352 with the updated contents of the scene memory 252.

On the other hand, the CPU 303 receives acoustic parameters from the user via the GUI program 353, and receives editing of the current memory 351 and the scene memory 352. The CPU 303 transmits edited contents of the current memory 351 and the scene memory 352 to the mixer 11. The mixer 11 synchronizes the contents of the current memory 251 and the scene memory 252 with the updated contents of the current memory 351 and the scene memory 352.

Accordingly, the user can control the acoustic device (signal processing engine) such as the mixer 11 by using the management apparatus 12.

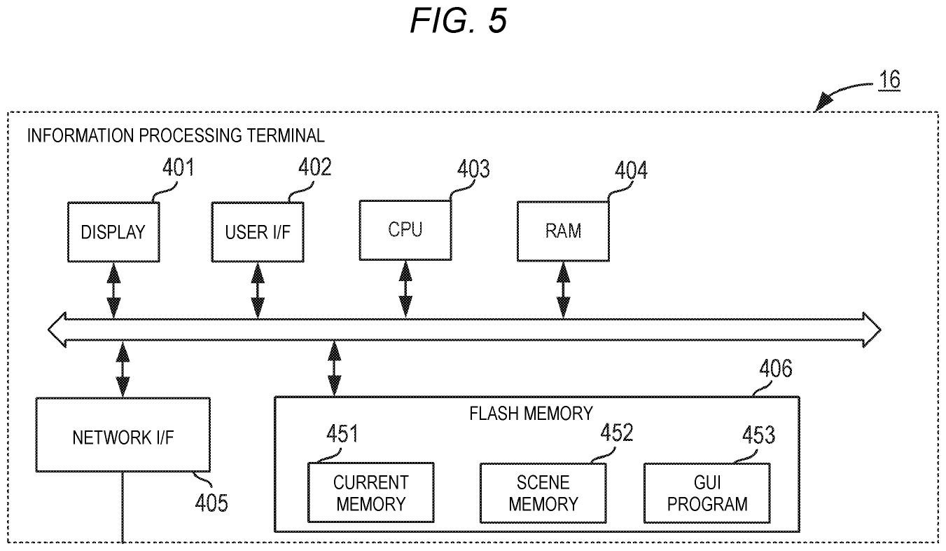

Next, FIG. 5 is a block diagram showing a configuration of the information processing terminal 16. The information processing terminal 16 is, for example, a general-purpose information processing apparatus such as a personal computer, a smartphone, or a tablet computer.

The information processing terminal 16 includes a display 401, a user I/F 402, a CPU 403, a RAM 404, a network I/F 405, and a flash memory 406.

The CPU 403 reads a program stored in the flash memory 406, which is a storage medium, into the RAM 404 to implement a predetermined function. The program read by the CPU 403 also does not need to be stored in the flash memory 406 in the own apparatus. For example, the program may be stored in a storage medium of an external apparatus such as a server. In this case, the CPU 403 may read the program from the server into the RAM 404 and execute the program each time.

The flash memory 406 includes a current memory 451, a scene memory 452, and a GUI program 453. The current memory 451 and the scene memory 452 correspond to a second parameter memory of the present invention. The GUI program 453 corresponds to a second program code for providing a GUI.

The information processing terminal 16 provides the user with a GUI by a second system including the current memory 451, the scene memory 452, and the GUI program 453. The GUI program 453 may also be a native application program that operates on an operating system of the information processing terminal 16, but may be, for example, a web application program. When the GUI program 453 is the web application program, the user receives a GUI from the GUI program 453 via an application program of a web browser. The user can edit the current memory 451 and the scene memory 452 via the GUI program 453. In the present embodiment, the second parameter memory has the same memory structure as that of the first parameter memory. That is, the current memory 451 and the scene memory 452 have the same memory structure as those of the current memory 351 and the scene memory 352. However, the second parameter memory does not need to have exactly the same memory structure as that of the first parameter memory, and may have the same memory structure in at least a part thereof. For example, acoustic parameters indicating settings for the CUE bus for the monitor may not be present in the current memory 451 and the scene memory 452.

Also, “Having the same memory structure in at least a part thereof” does not mean that the same data is stored in the same region in a physical memory. Even when the same data is stored in different regions, it can be said that “having the same memory structure in at least a part thereof”.

In a state where the information processing terminal 16 is connected to the management apparatus 12 via the network I/F 405, the user can receive the GUI from the GUI program 353 via the application program of the web browser. In this case, the user can edit the current memory 351 and the scene memory 352 via the GUI program 353.

In this way, when the GUI program 353 and the GUI program 453 are web application programs, the information processing terminal 16 can edit the current memory 351 and the scene memory 352 of the management apparatus 12 via a general-purpose application program of a web browser without using a dedicated operating system and an application program.

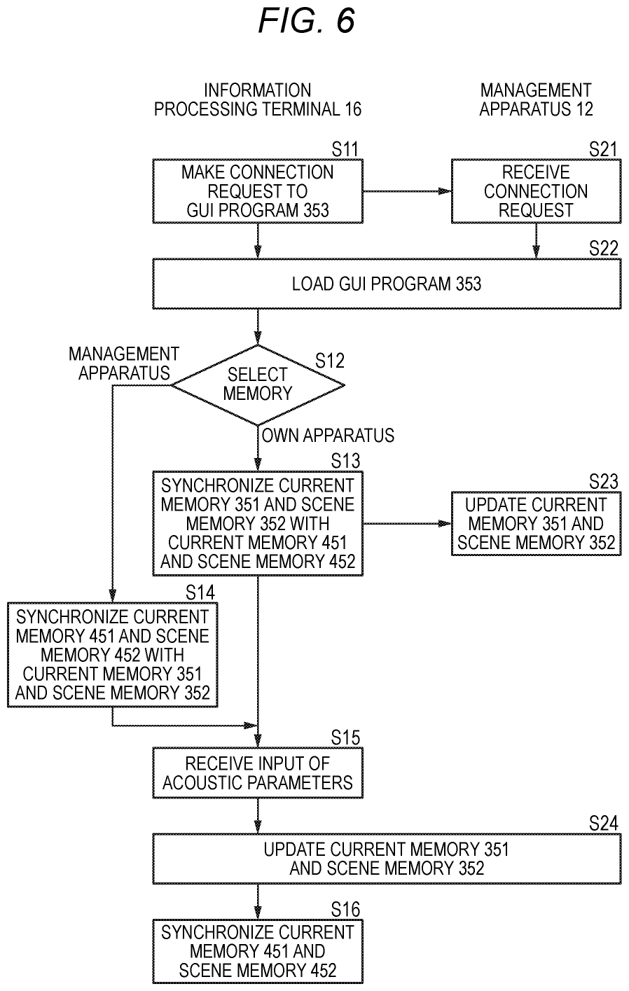

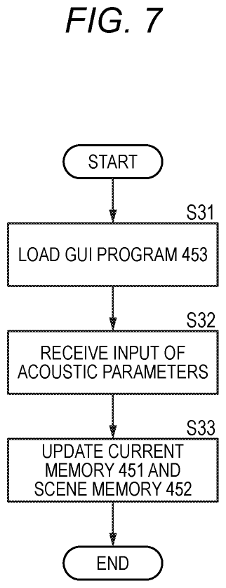

FIG. 6 is a flowchart showing an operation of the information processing terminal 16 in a connected state with the management apparatus 12. FIG. 7 is a flowchart showing an operation of the information processing terminal 16 in a disconnected state with the management apparatus 12.

As shown in FIG. 6, the information processing terminal 16 in a state of being connected to the management apparatus 12 makes a request to the management apparatus 12 to connect to the GUI program 353 (S11). The management apparatus 12 receives the connection request (S21) and loads the GUI program 353 in the information processing terminal 16 (S22). As described above, when the GUI program 353 is the web application program, the information processing terminal 16 can load the GUI program 353 in the own apparatus by accessing the GUI program 353 via the web browser.

When loading the GUI program 353, the information processing terminal 16 firstly receives selection of a memory (S12). That is, the information processing terminal 16 receives selection of whether the memory to be used is the current memory 351 and the scene memory 352 of the management apparatus 12, or the current memory 451 and the scene memory 452 of the own apparatus.

When the memories of the own apparatus are selected, the information processing terminal 16 synchronizes the current memory 351 and the scene memory 352 with the current memory 451 and the scene memory 452 (S13). In other words, the information processing terminal 16 transfers values of the current memory 451 and the scene memory 452 to the current memory 351 and the scene memory 352. Accordingly, the current memory 351 and the scene memory 352 of the management apparatus 12 are updated (S23).

On the other hand, when the memories of the management apparatus 12 are selected, the information processing terminal 16 synchronizes the current memory 451 and the scene memory 452 with the current memory 351 and the scene memory 352 (S14). In other words, the information processing terminal 16 transfers values of the current memory 351 and the scene memory 352 to the current memory 451 and the scene memory 452.

Then, the information processing terminal 16 receives input of the acoustic parameters from the user via the GUI program 353 (S15). The user edits the contents of the current memory 351 or edits the contents of the scene memory 352.

When receiving the input of the acoustic parameters, the information processing terminal 16 updates the values of the current memory 351 and the scene memory 352 (S24). Further, when the current memory 351 and the scene memory 352 are updated, the information processing terminal 16 synchronizes the current memory 451 and the scene memory 452 with the current memory 351 and the scene memory 352 (S16). In other words, the information processing terminal 16 transfers the values of the current memory 351 and the scene memory 352 to the current memory 451 and the scene memory 452.

On the other hand, as shown in FIG. 7, in a state where the information processing terminal 16 is not connected to the management apparatus 12, the information processing terminal 16 loads the GUI program 453 of the own apparatus (S31). As described above, when the GUI program 453 is the web application program, the information processing terminal 16 can load the GUI program 453 by accessing the GUI program 453 via the web browser.

Then, the information processing terminal 16 receives input of the acoustic parameters from the user via the GUI program 453 (S32). The user edits contents of the current memory 451 or edits contents of the scene memory 452. When receiving the input of the acoustic parameters, the information processing terminal 16 updates the values of the current memory 451 and the scene memory 452 (S33).

In this way, in the state where the information processing terminal 16 is not connected to the management apparatus 12, the information processing terminal 16 loads the GUI program 453 of the own apparatus and receives editing of the current memory 451 and the scene memory 452 via the GUI program 453.

Accordingly, the user can edit acoustic parameters such as scene data even in a place other than a venue where an acoustic device is installed (for example, a concert hall), and can directly edit the acoustic parameters such as scene data of the acoustic device even in the venue.

In the state where the information processing terminal 16 is not connected to the management apparatus 12, the current memory 451 and the scene memory 452 are not synchronized with the current memory 351 and the scene memory 352 of the management apparatus 12. Therefore, in the state where the information processing terminal 16 is not connected to the management apparatus 12, the current memory 451 and the scene memory 452 have values different from those of the current memory 351 and the scene memory 352.

Then, as shown in FIG. 6, when connected to the management apparatus 12, the information processing terminal 16 receives selection of any one of the current memory 351 and the scene memory 352 (first parameter memory) of the management apparatus 12 and the current memory 451 and the scene memory 452 (second parameter memory) of the information processing terminal 16. Accordingly, when the user edits the acoustic parameters in a place other than the venue and then returns to the venue where the acoustic device is installed, the user can also reflect the acoustic parameters edited by the information processing terminal 16 in the acoustic device in the venue, and can also maintain the acoustic parameters already set in the acoustic device in the venue.

When connected to the management apparatus 12, the information processing terminal 16 receives input of the acoustic parameters by the GUI program 353 to update the current memory 351 and the scene memory 352 (first parameter memory). When the first parameter memory is updated, the information processing terminal 16 updates the current memory 451 and the scene memory 452 (second parameter memory) in synchronization with the updated first parameter memory. Accordingly, the user can directly edit the acoustic parameters of the acoustic device in the venue by using the information processing terminal 16.

The information processing terminal 16 directly edits the current memory 351 and the scene memory 352 (first parameter memory) of the management apparatus 12, and then synchronizes the current memory 451 and the scene memory 452 (second parameter memory) of the own apparatus. In this way, the acoustic parameter editing system of the present embodiment changes the first parameter memory of the management apparatus 12 connected to a sound signal processing engine even when editing the acoustic parameters by using the information processing terminal 16 not connected to the sound signal processing engine. Therefore, the edited acoustic parameters are immediately reflected in the sound signal processing engine.

The description of the present embodiment is to exemplify the present invention in every point and is not intended to restrict the present invention. The scope of the present invention is indicated not by the above embodiment but by the scope of the claims. The scope of the present invention is intended to include meanings equivalent to the claims and all modifications within the scope.

For example, the sound signal processing engine is not limited to the mixer 11. For example, the management apparatus 12 may include a DSP (for example, sound signal processing engine) in the own apparatus. The sound signal processing may be performed by a CPU, an FPGA, or the like. That is, the sound signal processing engine may have any configuration such as a CPU, a DSP, or an FPGA. Further, an apparatus (for example, a server) different from the management apparatus 12 may function as the sound signal processing engine that performs the sound signal processing.

What is claimed is:

1. An acoustic parameter editing method for a management apparatus and a terminal, wherein the management apparatus includes a first parameter memory configured to indicate an acoustic parameter and is connected to a sound signal processing engine configured to perform a sound signal processing by reflecting the acoustic parameter, and the terminal includes a second parameter memory that has a same memory structure as a memory structure of the first parameter memory in at least a part of the second parameter memory, the acoustic parameter editing method comprising:
updating, by the management apparatus, the first parameter memory of the management apparatus after receiving the acoustic parameter;
updating, by the terminal, the second parameter memory of the terminal after receiving the acoustic parameter when the terminal is not connected to the management apparatus;
updating, by the terminal, the first parameter memory of the management apparatus after receiving the acoustic parameter when the terminal is connected to the management apparatus; and
updating, by the terminal, the second parameter memory in synchronization with the updated first parameter memory when the first parameter memory is updated.

2. The acoustic parameter editing method according to claim 1,
wherein when the terminal is connected to the management apparatus, the terminal receives a selection of the first parameter memory or the second parameter memory,
wherein upon receiving the selection of the first parameter memory, the terminal updates the second parameter memory in synchronization with the first parameter memory, and
wherein upon receiving the selection of the second parameter memory, the terminal updates the first parameter memory in synchronization with the second parameter memory.

3. The acoustic parameter editing method according to claim 1,
wherein each of the first parameter memory and the second parameter memory includes a current memory configured to indicate the acoustic parameter currently reflected in the sound signal processing engine.

4. The acoustic parameter editing method according to claim 1,
wherein each of the first parameter memory and the second parameter memory includes a scene memory in which the acoustic parameter to be reflected in the sound signal processing engine is stored as scene data.

5. The acoustic parameter editing method according to claim 1,
wherein the management apparatus includes a first system having the first parameter memory and a first program code for providing a graphical user interface,
wherein the terminal includes a second system having the second parameter memory and a second program code for providing a graphical user interface,
wherein when not connected to the management apparatus, the terminal provides a user with the graphical user interface by using the second system and receives the acoustic parameter, and
wherein when connected to the management apparatus, the terminal provides the user with the graphical user interface by using the first system and receives the acoustic parameter.

6. The acoustic parameter editing method according to claim 1,
wherein the management apparatus is connected to an acoustic device that includes the sound signal processing engine, and
wherein the management apparatus receives the acoustic parameter from the acoustic device and updates the first parameter memory.

7. An acoustic parameter editing system comprising:
a management apparatus that includes a first parameter memory configured to indicate an acoustic parameter and that is connected to a sound signal processing engine configured to perform a sound signal processing by reflecting the acoustic parameter; and
a terminal that includes a second parameter memory having as a memory structure as a memory structure of the first parameter memory in at least a part of the second parameter memory,
wherein the management apparatus receives the acoustic parameter and updates the first parameter memory,
wherein when not connected to the management apparatus, the terminal receives the acoustic parameter and updates the second parameter memory,
wherein when connected to the management apparatus, the terminal receives the acoustic parameter and updates the first parameter memory, and
wherein when the first parameter memory is updated, the terminal updates the second parameter memory in synchronization with the updated first parameter memory.

8. The acoustic parameter editing system according to claim 7,
wherein when connected to the management apparatus, the terminal receives a selection of the first parameter memory or the second parameter memory,
wherein upon receiving the selection of the first parameter memory, the terminal updates the second parameter memory in synchronization with the first parameter memory, and
wherein upon receiving the selection of the second parameter memory, the terminal updates the first parameter memory in synchronization with the second parameter memory.

9. The acoustic parameter editing system according to claim 7,
wherein each of the first parameter memory and the second parameter memory includes a current memory configured to indicate the acoustic parameter currently reflected in the sound signal processing engine.

10. The acoustic parameter editing system according to claim 7,
wherein each of the first parameter memory and the second parameter memory includes a scene memory in which the acoustic parameter to be reflected in the sound signal processing engine is stored as scene data.

11. The acoustic parameter editing system according to claim 7,
wherein the management apparatus includes a first system having the first parameter memory and a first program code for providing a graphical user interface,
wherein the terminal includes a second system having the second parameter memory and a second program code for providing a graphical user interface,
wherein when not connected to the management apparatus, the terminal provides a user with the graphical user interface by using the second system and receives the acoustic parameter, and
wherein when connected to the management apparatus, the terminal provides the user with the graphical user interface by using the first system and receives the acoustic parameter.

12. The acoustic parameter editing system according to claim 7,
wherein the management apparatus is connected to an acoustic device that includes the sound signal processing engine, and
wherein the management apparatus receives the acoustic parameter from the acoustic device and updates the first parameter memory.

13. A management apparatus connected to a sound signal processing engine configured to perform a sound signal processing by reflecting an acoustic parameter, the management apparatus comprising:
a first parameter memory configured to indicate an acoustic parameter,
wherein the management apparatus receives the acoustic parameter and updates the first parameter memory,
wherein the management apparatus is connected to a terminal including a second parameter memory having a same memory structure as a memory structure of the first parameter memory in at least a part of the second parameter memory,
wherein when not connected to the management apparatus, the terminal receives the acoustic parameter and updates the second parameter memory,
wherein when connected to the management apparatus, the terminal receives the acoustic parameter and updates the first parameter memory, and
wherein when the first parameter memory is updated, the terminal updates the second parameter memory in synchronization with the updated first parameter memory.

14. A terminal connected to a management apparatus including a first parameter memory configured to indicate an acoustic parameter, the terminal comprising:
a second parameter memory having a same memory structure as a memory structure of the first parameter memory in at least a part of the second parameter memory,
wherein the management apparatus is connected to a sound signal processing engine configured to perform a sound signal processing by reflecting the acoustic parameter, and receives the acoustic parameter to update the first parameter memory,
wherein when not connected to the management apparatus, the terminal receives the acoustic parameter to update the second parameter memory,
wherein when connected to the management apparatus, the terminal receives the acoustic parameter to update the first parameter memory, and
wherein when the first parameter memory is updated, the terminal updates the second parameter memory in synchronization with the updated first parameter memory.

15. An acoustic parameter editing method for a management apparatus that includes a first parameter memory configured to indicate an acoustic parameter and that is connected to a sound signal processing engine configured to perform a sound signal processing by reflecting the acoustic parameter, the acoustic parameter editing method comprising:
updating, by the management apparatus, the first parameter memory of the management apparatus after receiving the acoustic parameter;
connecting the management apparatus to a terminal including a second parameter memory having a same memory structure as a memory structure of the first parameter memory in at least a part of the second parameter memory;
updating, by the terminal, the second parameter memory after receiving the acoustic parameter when the terminal is not connected to the management apparatus;
updating, by the terminal, the first parameter memory after receiving the acoustic parameter when the terminal is connected to the management apparatus;
updating, by the terminal, the second parameter memory in synchronization with the updated first parameter memory when the first parameter is updated.

16. An acoustic parameter editing method for a terminal that is connected to a management apparatus including a first parameter memory configured to indicate an acoustic parameter and that includes a second parameter memory having a same memory structure as a memory structure of the first parameter memory in at least a part of the second parameter memory, the management apparatus being connected to a sound signal processing engine configured to perform a sound signal processing by reflecting the acoustic parameter, and receiving the acoustic parameter to update the first parameter memory, the acoustic parameter editing method comprising:
updating, by the terminal, the second parameter memory after receiving the acoustic parameter when the terminal is not connected to the management apparatus;
updating, by the terminal, the first parameter memory after receiving the acoustic parameter when the terminal is connected to the management apparatus; and
updating, by the terminal, the second parameter memory in synchronization with the updated first parameter memory when the first parameter memory is updated.
